(19) United States
(12) Patent Application Publication
(10) Pub. No.: US 2016/0066513 A1
(43) Pub. Date: Mar. 10, 2016

(54) LANDSCAPING MATERIAL MAINTENANCE

(71) Applicant: EMERSON PAUL GRAY, MEDICINE HAT (CA)

(72) Inventor: EMERSON PAUL GRAY, MEDICINE HAT (CA)

(21) Appl. No.: 14/482,046

(22) Filed: Sep. 10, 2014

(51) Int. Cl. A01G 1/12; A47L 9/10; A47L 7/00

(52) U.S. Cl. CPC A01G 1/125; A47L 7/009; A47L 9/104

(57) ABSTRACT

A landscaping material cleaning technique involves the application of a vacuum cleaner attachment. This attachment defines a conduit extending from a suction inlet to a suction outlet. The suction outlet is sized and shaped to connect to a vacuum cleaner in fluid communication therewith. The attachment further includes a number of teeth extending away from the inlet and optionally a grating that extends across the conduit to define a number of apertures circumscribed by a conduit margin. These apertures are sized and shaped to selectively separate fine particulate debris from a coarser landscaping medium when suction is applied through the conduit. The teeth project out of one end of the conduit to serve as a rake for grooming the coarser medium as the particulate debris is separated from it by suction applied through the conduit with a vacuum cleaner.

### BACKGROUND

The present invention relates to cleaning systems and more particularly, but not exclusively, relates to apparatus, devices, techniques, methods, and systems suitable for separating debris from a coarser landscaping medium.

There are many schemes for keeping landscaping fit. One approach utilizes blowers to clear away leaves and similar debris; however, this approach often just moves debris from one place in the yard to another—not a very tidy solution. Furthermore, sand, anthill soil, dead grass, and similar debris are not easily moved in this manner. Accordingly, it may be desirable to use a different technique to remove such debris. Moreover, there is a desire to remove debris from landscaping materials such as landscaping gravel and bark chips while leaving the landscaping materials in place—or in an improved distribution. The selective removal of sand and similar debris from these landscaping materials is particularly challenging. Even for conventional grass lawns, conventional devices leave a lot to be desired as to the removal of dead grass and the like. For all these different forms of landscaping material, current schemes to remove debris, rake it, groom it, and/or aerate it are often cumbersome to use, making it difficult to readily and consistently obtain a satisfactory result. Thus, there is an ongoing demand for further contributions in this area of technology.

### SUMMARY

One embodiment of the present application includes a unique technique for cleaning landscaping materials. This technique finds application in the removal of sand, other fine particulate debris such as soil/dirt, light debris such as dried leaves or grass, or the like from landscaping including at least one of a grass lawn, bark chips, bark pieces, wood chips, wood pieces, rocks, pebbles, cobbles, crushed stone, mulch, and pea-sized or larger gravel material. This technique can also be extended to cleaning any coarse medium by suction removal selective to finer/lighter debris.

Another form of the application is a unique vacuum cleaner attachment. This attachment defines a conduit extending from a suction inlet to a suction outlet. The suction outlet is sized and shaped to connect to a vacuum cleaner in fluid communication therewith. The attachment further includes a grating and several teeth connected to the grating. The grating extends across the conduit to define a number of apertures circumscribed by a conduit margin. The apertures are sized and shaped to selectively separate fine debris from a coarser landscaping medium when suction is applied through the conduit. The teeth project from the grating out of one end of the conduit to serve as a rake for grooming the coarser medium as the particulate debris is separated from it by suction applied through the conduit with the vacuum cleaner.

Still another embodiment of the present application is directed to a method, comprising: providing a vacuum cleaner including an attachment coupling tube; selecting a vacuum cleaner attachment to separate fine debris from a coarser landscaping medium, the attachment defining a conduit therethrough and including a grating extending across it to define a number of apertures sized and shaped to pass the fine debris therethrough while at least partially blocking the coarser landscaping medium—also, several teeth connect to the grating. This embodiment further includes coupling one end of the conduit to the attachment coupling tube to be in fluid communication therewith; and cleaning the coarser landscaping medium by moving the vacuum cleaner attachment relative thereto while applying suction through the conduit with the vacuum cleaner to separate the fine matter from the coarser landscaping medium.

A further form includes: a vacuum cleaner suction source; a debris collection vessel; and a vacuum cleaner head in fluid communication with the vacuum cleaner suction source and the debris collection vessel. The vacuum cleaner head defines a conduit therethrough and includes a grating extending across the conduit and several teeth extending from the grating toward one end of the conduit with a margin of the conduit circumscribing the teeth. The grating defines a number of apertures sized and shaped to selectively separate debris from a coarser medium when suction is applied through the conduit from the suction source.

Optional variations of this form include: the teeth extending out of the conduit, means for raking the coarser medium, the teeth numbering at least twelve, the teeth being arranged in several rows that each include three or more of the teeth, a tube coupling the vacuum cleaner head to the vacuum source and the debris collection vessel, the vacuum cleaner head being in the form of an attachment operatively detachable from and re-attachable to the vacuum cleaner to allow for exchange of different attachments as different corresponding vacuum cleaner heads, and/or the vacuum cleaner head is in the form of an attachment that has a friction fit to a vacuum cleaner tube and different attachments each are friction fit to the tube.

In another embodiment a device includes: a vacuum cleaner attachment defining a conduit therethrough, the conduit extending from a suction inlet to a suction outlet, the suction outlet being sized and shaped to connect to and detach from a vacuum cleaner to allow exchange with one or more other vacuum cleaner attachments, the vacuum cleaner attachment including a grating and at least six teeth connected to the grating, the grating extending across the conduit to define a number of apertures circumscribed by a conduit margin, the apertures being sized and shaped to selectively separate fine particulate matter from a coarser medium when suction is applied through the conduit, and the teeth project from the grating through the conduit and out of the inlet.

A further embodiment is directed to: providing a vacuum cleaner including an attachment coupling tube; selecting a vacuum cleaner attachment to clean a landscaping medium mixed with a finer particulate debris, the attachment defining a conduit including an intake opposite an outlet to provide fluid communication therebetween and including a grating extending across the conduit to define a number of apertures sized and shaped to pass finer particulate debris therethrough while at least partially blocking the landscaping medium, and the attachment intake further includes several teeth connected to the grating; connecting the attachment to the tube; placing the intake over the landscaping medium; and operating the vacuum cleaner during the placement over the landscaping medium to apply suction through the conduit to clean the landscaping medium by separating the finer particulate matter from the landscaping medium.

Still a further embodiment is directed to an apparatus, comprising: a vacuum cleaner suction source; a debris collection vessel; and a vacuum cleaner head in fluid communication with the vacuum cleaner suction source and the debris collection vessel. The vacuum cleaner head defines a conduit therethrough with an intake opening and includes a grating extending across the conduit and several teeth connected to the grating to extend from the grating through the conduit and out of the intake opening. A margin of the conduit circumscribes the teeth, the grating defines a number of apertures sized and shaped to selectively separate debris from a coarser medium when suction is provided by the suction source through the conduit of the vacuum cleaner head with the intake opening placed over the coarser medium within a proximity sufficient to be operative.

Yet a further embodiment is directed to: a vacuum cleaner attachment defining a conduit therethrough that extends from an intake opening to an outlet opening. The outlet opening is sized and shaped to connect to and detach from a vacuum cleaner to allow exchange with one or more other vacuum cleaner attachments. The vacuum cleaner attachment includes a grating and 6 or more projections connected to the grating that are spaced apart from each other and protrude from the grating through the conduit out of the intake opening. The grating extends across the conduit to define a number of apertures sized and shaped to selectively separate debris from a coarser medium when suction is applied through the conduit.

Another embodiment includes: providing a vacuum cleaner including an attachment coupling tube; selecting a landscaping medium with debris to remove therefrom; and selecting a vacuum cleaner attachment in accordance with the landscaping medium. The vacuum cleaner attachment defines a conduit therethrough that extends from an inlet to an outlet. The attachment further includes at least six rigid projections spaced apart from one another proximate to the inlet and each extending away from the inlet a distance of at least 0.750 of an inch. The embodiment further may include operating the vacuum cleaner with the attachment connected to the attachment coupling tube to apply suction through the conduit while raking the landscaping medium with the projections to remove debris from the landscaping medium. Other embodiments include: apparatus, devices, and systems to implement and/or practice this embodiment.

In one variation of this embodiment, the projections may number at least 12 with 4 of the projections extending along a first side of the inlet and 4 of the projections extending along a second side of the inlet opposite the first side, and the distance is less than or equal to 1.750 inches.

In a further variation, the landscaping medium includes a grass lawn and the distance is in a range from about 1.250 inches through about 1.750 inches.

In still a further variation, the landscaping medium includes at least one of bark chips, bark pieces, wood chips, wood pieces, rocks, pebbles, cobbles, crushed stone, mulch, and pea-sized or larger gravel material, and the attachment includes a grating extending across the conduit to define a number of apertures sized and shaped to pass the debris therethrough while at least partially blocking the landscaping medium.

In a further form of the embodiment, the landscaping medium includes at least one of bark chips, bark pieces, wood chips, wood pieces, rocks, pebbles, cobbles, crushed stone, mulch, and pea-sized or larger gravel material, the attachment includes a grating extending across the conduit to define a number of apertures sized and shaped to pass the debris therethrough while at least partially blocking the landscaping medium, the distance is in a range from about 1.000 inch through about 1.500 inches, 3 or more of the projections connect to the grating, the 3 or more projections contact the grating where connected thereto, and the 3 or more projections extend from the grating through the conduit and out of the inlet.

For another form, the landscaping medium includes at least one of bark chips, bark pieces, wood chips, wood pieces, rocks, pebbles, cobbles, crushed stone, mulch, and pea-sized or larger gravel material, the attachment includes a grating extending across the conduit to define a number of apertures sized and shaped to pass the debris therethrough while at least partially blocking the landscaping medium, the projections number 9 or more and are arranged in at least 3 rows with each including at least 3 of the projections, a first one of the rows extends along one side of the inlet, a second one of the rows extends along another side of the inlet opposite the one side, and a third one of the rows extends from the grating between the first one of the rows and the second one of the rows.

For another form, the landscaping medium includes a grass lawn and the distance is in a range from about 1.125 inches through about 1.875 inches.

Other forms, embodiments, applications, implementations, techniques, objects, benefits, advantages, and variations will become apparent from the description and figures provided herewith.

### BRIEF DESCRIPTION OF THE DRAWING(S)

FIG. 1 is a partially diagrammatic view of a landscaping media cleaning system of the present application.

FIG. 2 is a partially diagrammatic side view of the vacuum cleaner attachment of the system of FIG. 1 as applied to coarser landscaping media intermixed with finer debris.

FIG. 3 is a partially diagrammatic view of the bottom of the vacuum cleaner attachment of FIGS. 1 and 2.

FIG. 4 is a perspective view of the bottom of the vacuum cleaner attachment of FIGS. 1-3.

FIG. 5 is a perspective view of the rear of the vacuum cleaner attachment of FIGS. 1-4.

A further view of the front of the vacuum cleaner attachment of FIGS. 1-5 is not separately depicted because relevant information about the front is provided by FIGS. 1-5 and accompanying text. The front is otherwise plain and unadorned.

FIG. 6 is a perspective view of the bottom of an alternative vacuum cleaner attachment of the present application; where outer surfaces not shown correspond to like surfaces of the attachment of FIGS. 1-5, possibly with different proportions/dimensions based on the illustrations. Generally the top, front, rear, and side outer surfaces of the FIG. 6 attachment are plain and adorned.

### DETAILED DESCRIPTION OF REPRESENTATIVE EMBODIMENTS

For the purposes of promoting an understanding of the principles of any invention provided herein, reference will now be made to the embodiments illustrated in the drawing(s) and specific language will be used to describe the same. It will nevertheless be understood that no limitation of the scope of any invention is thereby intended. Any alterations and further modifications in the described embodiments, and any further applications of the principles of the same as described herein are contemplated as would normally occur to one skilled in the art to which they relate.

One embodiment of the present application is directed to a unique technique and device for cleaning a landscaping medium. Included may be a vacuum cleaner attachment with a screen selective to debris finer than the landscaping medium and/or with several projections extending through its intake opening. The projections can be used to free the debris from, rake, groom, arrange, turn, spread, aerate, stir-up, or otherwise redistribute a landscaping medium as suction is applied through the intake opening of the attachment to remove the finer debris intermixed with the landscaping medium.

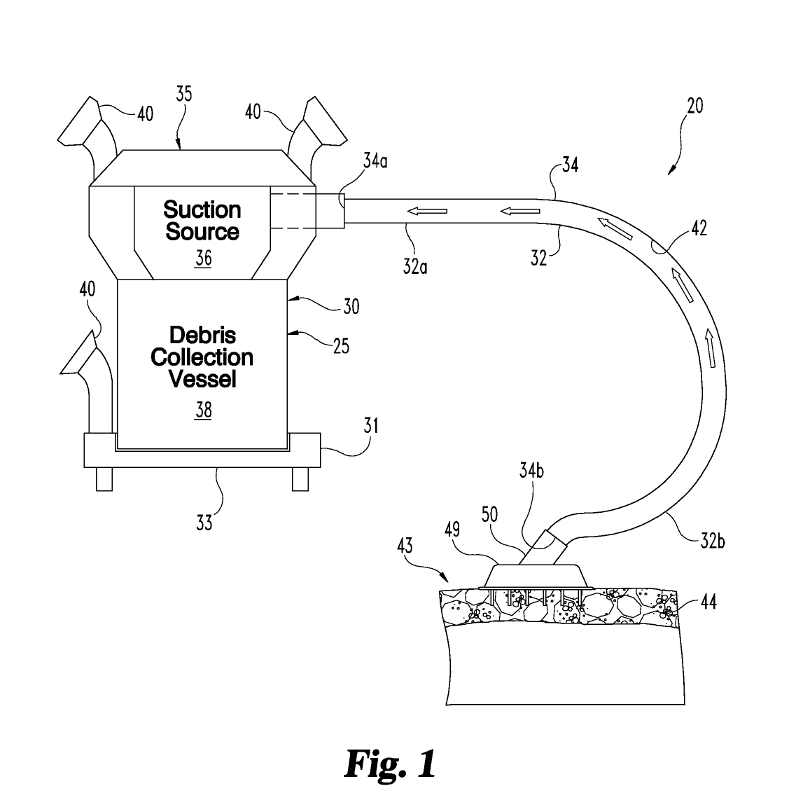

FIG. 1 depicts another embodiment in the form of vacuum system 20. System 20 includes vacuum cleaner 30 comprising suction collector subsystem 25 and attachment tube 32 in the form of a flexible hose 34 connected to subsystem 25. Tube 32 includes debris suction passageway 42 therethrough. Hollow arrows indicate the direction of debris travel through passageway 42 when suction is applied through tube 32. Tube 32 further includes end portion 32b opposite end portion 32a. In correspondence, end portion 32a terminates with passageway opening 34a and end portion 32b terminates with passageway opening 34b positioned opposite passageway opening 34a. Passageway 42 intersects opposing passageway openings 34a and 34b. Subsystem 25 includes suction source 36 and detritus/debris collection vessel 38 in fluid and operative communication with each other to function in a standard manner in accordance with the various embodiments and forms described hereinafter in connection with FIGS. 1-6. Referring specifically to FIG. 1, vacuum system 20 further includes base 31 in the form of a carrier 33 for suction collector subsystem 25. Carrier 33 includes enclosure 35 housing suction source 36 and detritus/debris collection vessel 38.

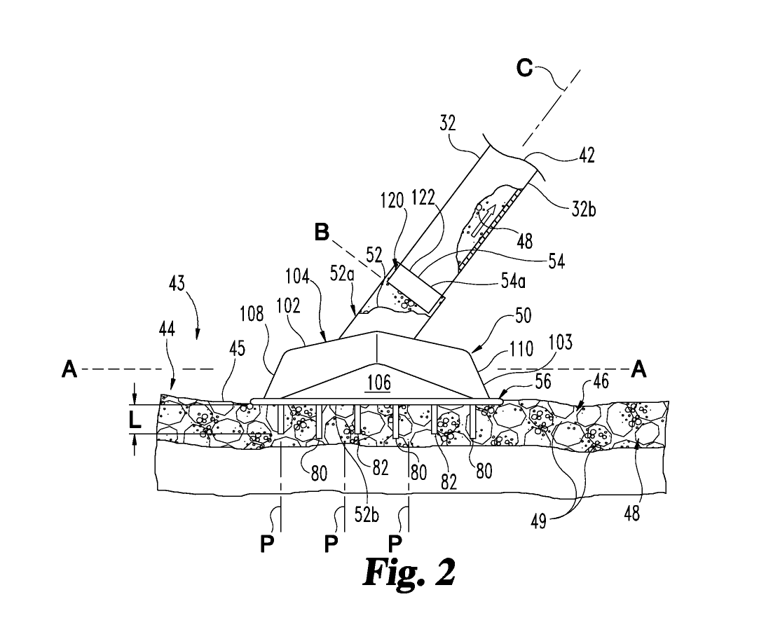

In the illustrated embodiment, vacuum cleaner 30 includes vacuuming head 49 in the form of vacuum cleaner attachment 50. Attachment 50 is shown in use in FIG. 1 as further detailed hereinafter in connection with FIG. 2. System 20 further includes other vacuum cleaner attachments 40 that may be optionally carried with base 31, carrier 33, and/or enclosure 35. Any of attachments 40 may be used in place of and exchanged with vacuum cleaner attachment 50 presently selected for use with vacuum cleaner 30 as more specifically explained hereinafter.

Referring additionally to FIG. 2, attachment 50 is further depicted in more detail; where like reference numerals refer to like features previously described in connection with FIG. 1. Attachment 50 includes proximal end discharge portion 52a opposite distal end intake portion 52b. Portions 52a and 52b collectively define conduit 52 extending through attachment 50. Portion 52a includes debris outlet 54 with opening 54a of conduit 52, and is coupled to and in contact with end portion 32b of tube 32 to place passageway 42 in fluid communication with conduit 52. Portion 52b of attachment 50 includes debris inlet/intake 56 with inlet/intake opening 56a of conduit 52 opposite opening 54a. Intake 56 is shown within operating proximity of landscaping arrangement 43 at a selected outdoor site 44. Landscaping arrangement 43 at site 44 includes material mixture 45 of one or more landscaping materials and undesired debris 48. Such one or more landscaping materials are designated as landscaping medium 46 in FIG. 2. Typically, each piece of landscaping medium 46 is structured to be much larger than and/or to weigh considerably more than pieces of debris 48 in mixture 45 that are desired to be separated therefrom (as more specifically described hereinafter). By way of non-limiting example, landscaping medium 46 includes one or more of: bark chips, bark pieces, wood chips, wood pieces, rocks, pebbles, cobbles, crushed stone, mulch, and pea-sized or larger gravel (further designated by reference numeral 49); and debris 48 includes one or more of: sand, fine particulate/friable inorganic matter (such as sand, silt, and clay), dirt, soil, earth, loam, anthill mounds, dust, powder, gravel smaller than pea-size, particulate organic matter (such as many types of seeds, crushed leaves, and saw dust), granules and/or solid matter readily deformable to a smaller size or shape by action of suction through attachment 50 and/or otherwise differ from material 49 in terms of weight, density, and/or size to be selectively picked-up with suction provided through intake 56 (such as dried leaves)—as further described hereinafter.

Next, referring to FIGS. 1 and 2, general operation of system 20 is further considered before providing more details about attachment 50. Suction source 36 may be of a conventional type, such as an air pump driven by an electricity-powered motor. When operating, suction source 36 generates a partial vacuum to correspondingly provide suction through passageway 42 and conduit 52 in the direction of the associated hollow arrows shown in FIGS. 1 and 2 to remove debris 48 subject to movement by this suction. Debris 48 is directed by suction source 36 to debris collection vessel 38 in a standard manner. Vessel 38 may be of any standard type, such as a removable bag carried internal to enclosure 35 along with source 36; a replaceable bag external to enclosure 35 to which the debris 48 is directed; a rigid removable container internal to enclosure 35, and/or a rigid container integral to enclosure 35 of vacuum cleaner 30 just to name a few examples. Indeed, in one embodiment, base 31, carrier 33, source 36, and vessel 38 are configured as a conventional canister type of vacuum cleaner 30, such as a standard SHOP VAC or the like; where vessel 38 is an internal rigid canister/container that holds the suctioned debris 48 until opened, separated from source 36, and emptied.

Alternatively or additionally, vacuum cleaner 30 may be of a wet/dry type; provided with source 36 and vessel 38 being on a mobile form of base 31, such as one with wheels to facilitate relocation of vacuum cleaner 30; and/or provided in a traditional “upright” vacuum cleaner configuration. In one preferred embodiment, vacuum cleaner 30 is of a SHOP VAC canister type, and/or attachments 40 are each of the type typically provided with a SHOP VAC, a wet/dry vacuum, or other canister type. Alternatively or additionally, vacuum cleaner 30 is of the type configured to provide a pressurized air blowing output in one mode of operation and suction by partial vacuum in another mode (such modes may be provided by a “leaf blower” with an alternative vacuum mode for suction that directs debris into a vessel 38 in the form of an external, removable bag). In still another alternative or addition, vacuum cleaner 30 is configured to be strap-carried as a backpack or over-the-shoulder type. Likewise, attachment tube 32 is adapted to each different configuration. Alternatively, tube 32 may be of a rigid and/or fixed type relative to base 31, carrier 33, and/or enclosure 31; such that it is not provided in the form of a flexible hose 34 (not shown), and/or its length and sizing may be varied according to the specific configuration of other constituents of vacuum cleaner 30. In some alternatives, the length of tube 32 may be changed by the addition or removal of fixed-length rigid tubular sections with or without a flexible hose 34.

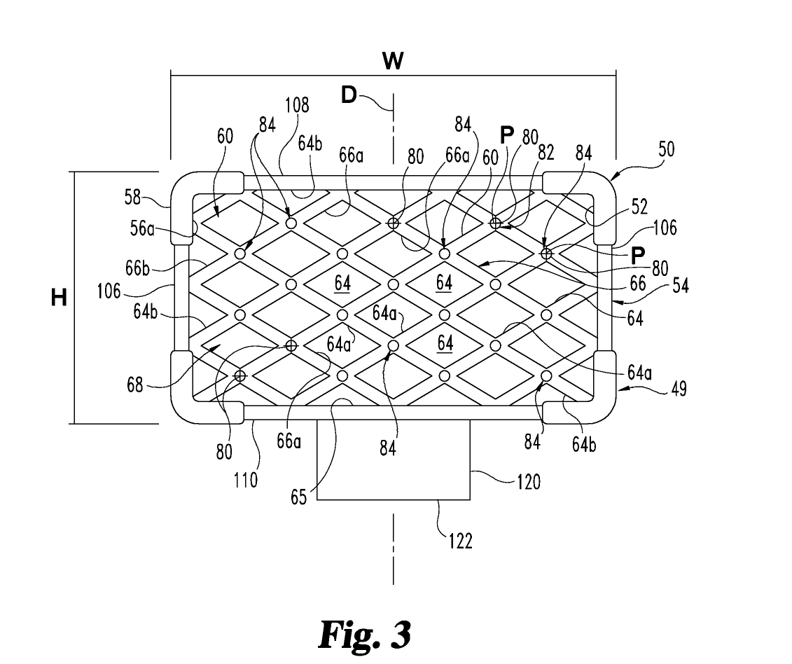

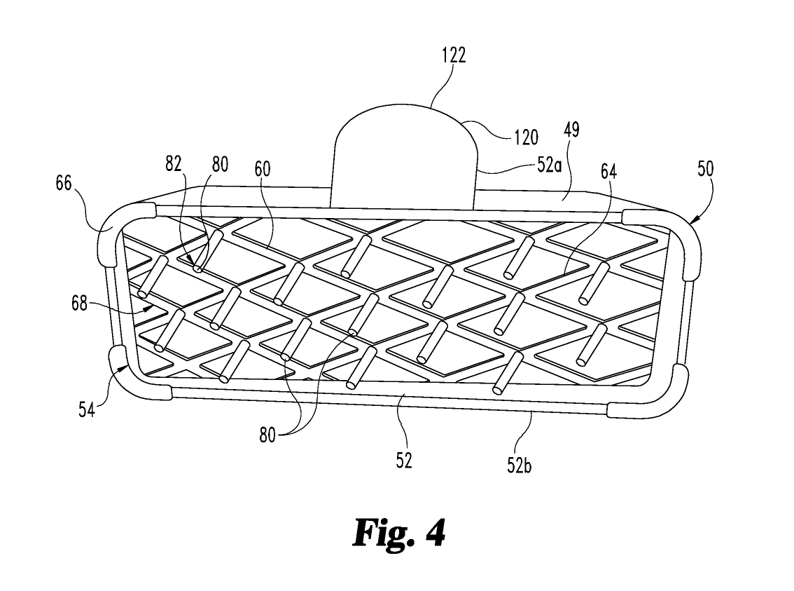

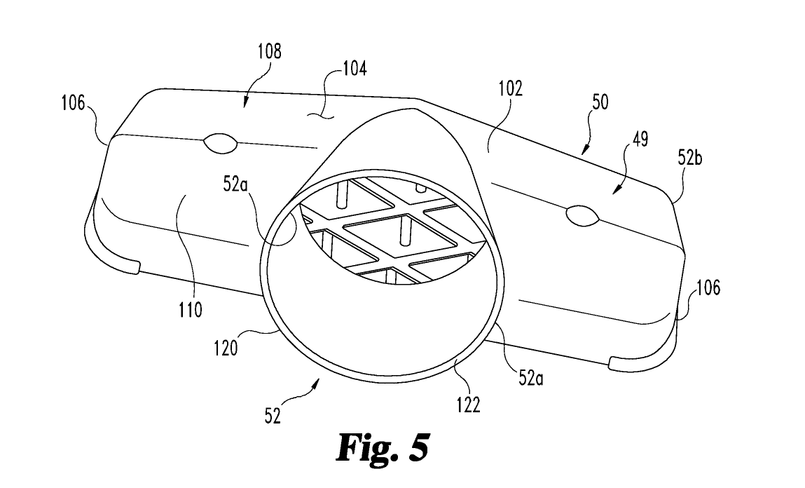

In the context of these nonlimiting variations of vacuum cleaner 30, further aspects of attachment 50 and its operation are next described with reference to FIGS. 2-5; where like reference numerals refer to like features previously described. The view plane of FIG. 2 is perpendicular to the view plane of FIG. 3, while FIGS. 4 and 5 provide bottom and rear perspective views of attachment 50. Among these figures, not all recurring features in the same figure may be designated by reference numeral to preserve clarity, and further a given feature appearing in multiple figures may not specifically be designated by reference numeral in all such figures to preserve clarity.

Attachment 50 includes housing 103 in the form of shoe 102. Shoe 102 may be comprised of a thermoset polymeric material, a thermoplastic polymeric material, a composite like fiberglass, metal, or such other material as would occur to those skilled in the art. Shoe 102 includes top portion 104 joined to opposing sidewall portions 106, front sidewall portion 108 and rear sidewall portion 110. Collectively, portions 104, 106, 108 and 110 comprise the sides and outer boundaries of intake 56. As shown in FIG. 3, these boundaries define an approximately rectangular profile/contour along a cross-sectional plane taken parallel to the FIG. 3 view plane and axis A—viewing attachment 50 from the bottom. This profile of attachment 50, coextensive with opening 56a, is represented by the dimensions of width W and height H diagrammatically depicted in FIG. 3. The aspect ratio of W to H is approximately 9 to 3, or equivalently, about 3 (aspect ratio 9/3=3). In one alternative form of attachment 50, the aspect ratio of W to H is approximately 3 to 14 or 14/3 (equal to approximately 4.667). In other embodiments, this profile may be approximately square (aspect ratio equal to about 1), circular (aspect ratio of about 1), or another shape (not shown).

Referring to FIGS. 3 and 5, discharge portion 52a includes connection collar 120, the boundaries of which are partially defined by shoe 102. Connection collar 120 terminates with proximal rim 122. Rim 122 defines opening 54a of discharge portion 52a. Collar 120 is sized and shaped to receive end portion 32b and opening 34b of tube 32 through opening 54a in a snug, at least partially sealed relationship (see cutaway of collar 120 in FIG. 2). Correspondingly, opening 34b intersects conduit 52, establishing fluid communication therebetween, to apply suction from tube 32 to conduit 52—drawing through opening 56a. Collar 120 is generally in the shape of a right circular cylinder with a circular cross-sectional profile taken perpendicularly along axis C on a plane perpendicular to the view plane of FIG. 2 and inclusive of axis B of FIG. 2. In correspondence, collar 120 defines a cylindrical portion of conduit 52 through attachment 50, as defined by discharge portion 52a, that intersects top portion 104 at an oblique angle taken between axes A and C (see FIG. 2). Attachment 50 is generally symmetric about a bisecting plane taken parallel to the view plane of FIG. 2 that includes axis D as shown in FIG. 3. In other embodiments, attachment 50 may present a different symmetry or lack symmetry altogether.

Intake 56 of attachment 50 includes grating 60 in the form of a screen 62 positioned to extend across conduit 52 positioned proximate to opening 56a of intake portion 52b, as perhaps best shown in FIGS. 3 and 4. Intake 56 further includes several elongate projections 80 in the form of teeth 82 connected to grating 60. Projections 80 protrude from grating 60, extending through conduit 52 and out past intake opening 56a (as perhaps best shown in FIGS. 2 and 4). Opening 56a is defined by intake rim 58 of intake 56 (as shown in FIG. 3). Grating 60 defines a number of apertures 64 circumscribed by margin 65 of the intake end of conduit 52. Apertures 64 include several regular apertures 64a that are uniformly sized and shaped approximately the same from one to the next, and several irregular apertures 64b that are differently shaped and/or sized from one to the next and/or smaller in area than the regular apertures 64a. In correspondence, partition 66 of grating 60 are comprised of a number of regular partition portions 66a generally sized and shaped the same as each other. Collectively, regular partition portions 66a define a repeating aperture and partition pattern 68 that provides regular apertures 64a. Several irregular partition portions 66b define the irregular apertures 64b closer to the border or margin 65 of conduit 52 than the regular partition portions 66a.

In the depicted embodiment, grating 60 is shown as a number of intersecting, crossing or joined members to provide partition portions 66a in a repeating diamond-shaped parallelogram pattern that defines diamond-shaped regular apertures 64a, and provide partition portions 66b in a partial diamond-shaped pattern that defines irregular apertures 64b extending between the regular apertures 64a and margin 65. Generally, irregular apertures 64b at least partially surround or encompass regular apertures 64a as may be observed in FIG. 3. Correspondingly, regular partition portions 66a of grating 60 are at least partially surrounded or encompassed by irregular partition portions 66b of grating 60. In other embodiments, apertures 64 and/or partition 66 are differently sized and/or shaped. In one alternative, partition 66 is provided by a uniform sheet of material that is shaped to define regular apertures 64a as a regular pattern of circular holes, such that there may or may not be irregular apertures 64b (not shown). Yet another alternative provides partition 66 with elongate, approximately parallel bars that define apertures 64 as a corresponding group of elongate, approximately parallel slots (not shown). In another alternative, the shape of each regular aperture 64s is approximately a rectangular or square type of quadrilateral polygon with corresponding shaping of partition 66 (not shown). In still others, margin 65 is sized and shaped; and partition 66 is structured so that there are more or fewer irregular apertures 64b and/or irregular partition portions 66b, while in others there more or fewer regular apertures 64a and/or regular partition portions 66a. In further embodiments, partition 66 may be fabricated from two or more pieces that are joined together or remain separate to provide the corresponding aperture and partition pattern 68, or may be fabricated from a single unitary piece that is cut, etched, stamped, pressed, or the like to provide aperture and partition pattern 68. In still other embodiments, grating 60 is absent.

Projections 80 are each connected to and in contact with grating 60 at approximately the point where portions/parts comprising grating 60 intersect, cross, join, or the like in correspondence to a vertex of one of the parallelogram-shaped regular apertures 64a. From these “cross-point” vertices, projections 80 each have a longitude extending along a longitudinal centerline axis P perpendicular to the view plane of FIG. 3. Axes P for each projection 80 are approximately parallel to each other (as designated by like-labeled cross hairs for a few representative examples). Each axis P is perpendicular to a plane common to and intersecting apertures 64 and partition 66. Such a plane is parallel to or coextensive with the view plane of FIG. 3, where the perpendicular projections 80 are viewed “on end”—each being represented by a circle. Accordingly, projections 80 each have a generally cylindrical cross-section on a plane perpendicular to its longitudinal centerline axis P and parallel to or coextensive with the view plane of FIG. 3. FIG. 2 provides a side view of projections 80 with representative axis P, and FIG. 4 shows projections 80 in a perspective view—both illustrating elongation. Projections 80 extend from grating 60 and/or opening 56a a distance L as diagrammatically illustrated in FIG. 2 of at least 0.0750 of an inch; however in other embodiments, L may be no more than one half an inch. In another embodiment, projections 80 extend a greater or lesser distance L and/or at one or more different angles relative to one or more apertures 64 and/or partition 66.

The interconnection of projections 80 with grating 60 places projections 80 in a spaced apart relationship to define a repeating tooth 82 pattern that in turn corresponds to aperture/partition pattern 68 (See FIGS. 3 and 4). As illustrated, pattern 82 includes at least twelve projections 80 arranged in rows 84 each including at least three projections 80 that are approximately equidistantly spaced apart from one to the next. In one embodiment, at least twelve projections 80 are arranged in at least three rows 84, with the rows 84 each having at least three members. In another embodiment, projections 80 number at least six in two or more rows 84 of three each, or at least nine projections 80 in three or more rows 84 of three each. In other embodiments, projections 80 may number less than six and/or may have spacing that differs with or without equidistant separation, discernable rows, and/or a regular spacing pattern. In another embodiment, projections 80 are absent.

Referring specifically to FIG. 2, application of attachment 50 to mixture 45 to selectively remove debris 48 is further described. It should be appreciated that landscaping medium 46 of the mixture 45 is generally desirable as an improvement in appearance, as an erosion deterrent, and/or as a mulch to deter weed growth, retain moisture, or the like—just to name a few examples. Over time, pieces of debris 48 become commingled with and interstitially bound by pieces of media 46 resulting in a deterioration in appearance, function, or the like. Pieces of medium 46 generally are much larger than pieces of debris 48, and debris 48 pieces typically weigh much less than typical pieces of media 46, and/or pieces of debris 48 are readily deformed to a size and shape removable through apertures 64 by suction through intake 56.

When applying suction to mixture 45 supplied by suction source 36 through tube 32 of system 20, it has been discovered that the configuration of intake 56 selectively separates and removes pieces of debris 48 from medium 46. A few of such separated pieces are shown as they travel through tube 32 in the cutaway of FIG. 2. In one preferred embodiment, grating 60 is structured so the diamond-shaped apertures 64a have one pair of opposing vertices separated from each other by about 2 centimeters and the remaining pair of opposing vertices of the given diamond-shaped aperture 64a are separated from each other by about 1 centimeter. In another preferred embodiment, apertures 64a of grating 60 each have a largest dimension (maximum dimension) of about 2 centimeters. In a more preferred embodiment, the maximum dimension is about 1 centimeter. In an even more preferred embodiment, the maximum dimension is about 5 millimeters. However, a smaller or larger maximum dimension may be employed.

It is theorized the arrangement of intake 56 is effective with common levels of suction from vacuum source 30 to remove pieces of debris 48 that are typically much smaller (<<) in size than pieces of medium 46, have a much lower weight and/or density than pieces of medium 46, and/or are readily deformable by action of the suction to be re-dimensioned to fit through an aperture 64 of grating 60 where pieces of medium 46 would not fit through. For instance, re-dimensioning occurs by separation of a single piece into two or more smaller pieces (like crushing or tearing a dried leaf constituent of debris 48), or folding/bending/deforming a piece to more readily fit through aperture 64 (like folding a piece of paper, dried grass, pine needle, or green leaf constituent of debris 48). It is preferred that pieces of debris 48 be sized with a maximum dimension 25% or less of a maximum dimension of typical pieces of medium 46. Alternatively or additionally, in another preferred embodiment debris pieces have a maximum dimension of 1 centimeter or less and landscaping medium pieces have a maximum dimension of more than 1 centimeter. In a more preferred embodiment, debris pieces have a maximum dimension of 5 millimeters or less and landscape medium pieces have a maximum dimension of at least 1 centimeter. For another preferred embodiment, system 20 selectively distinguishes between #9 gravel or smaller as debris 48 (separating it by suction) and #8 gravel or larger as medium 46 (leaving it behind). In an even more preferred embodiment, debris pieces have a maximum dimension of 2.5 millimeters or less and landscape medium pieces have a maximum dimension of 5 millimeters or more. In other embodiments, pieces of medium 46 or debris 48 may be differently sized, and/or grating 60 may be differently configured with differently sized and/or shaped apertures 64. For all these embodiments described herein and/or to which system 20 may be applied, it should be understood that any given mixture 45, pieces of medium 46 and/or debris 48 typically includes outliers, such that selective separation occurs for only some with the recited dimensional features. Indeed, for even the most ideal implementation, some pieces of debris 48 expected to be separated are left in mixture 45, and/or some pieces of medium 46 expected to be left unseparated are separated.

In addition to grating 60, it is theorized that projections 80 may also deter, retard, or prevent removal of at least some pieces of medium 46 by adding a “third dimension” to the two dimensional operation of grating 60 separation of debris 48 from media 46 by suction. That is, projections 80 provide a form of selective grating as viewed laterally, from the side of attachment 50. In addition, projections 80 provide a mechanism to rake or groom medium 46 and concurrently “stir-up” mixture 45 to facilitate freeing, release, and/or separation of debris 48 therefrom. Even so, in some embodiments, only a selective grating without projections is provided or only projections without the grating are provided. Grating 60 and projections 80 are made from a generally rigid material. For instance, grating 60 and/or projections 80 are made of a suitable metal, thermoplastic polymer, and/or thermoset polymer.

Several other alternative embodiments and variations of the present application are envisioned. In one alternative, head 49 is permanently attached to tube 32 such that there is no detachable/re-attachable attachment feature. For embodiments in which attachment 50 is configured to selectively attach to and detach from tube 32, one option is that this re-attachable, interchangeable configuration is provided by structuring collar 120 to engage tube 32 with a friction fit. In an alternative, attachment 50 connects to tube 32 with a bayonet arrangement secured by twisting one relative to the other. In another alternative, collar 120 and tube 32 are configured to attach and detach with threading on both that mutually engage upon twisting. Yet another alternative provides a spring-loaded nub on one that removably engages an opening in the other as commonly found on household vacuum cleaner systems. In still other embodiments, a different detachable coupling arrangement is used as would occur to those skilled in the art. The detachable nature of attachment 50 may be used to interchange one of attachments 40 with attachment 50 for performance of a task suitable to such exchange. In other alternatives there are more or fewer attachment projections/tines/teeth/spikes/prongs (if any) and/or may be with or without a grating.

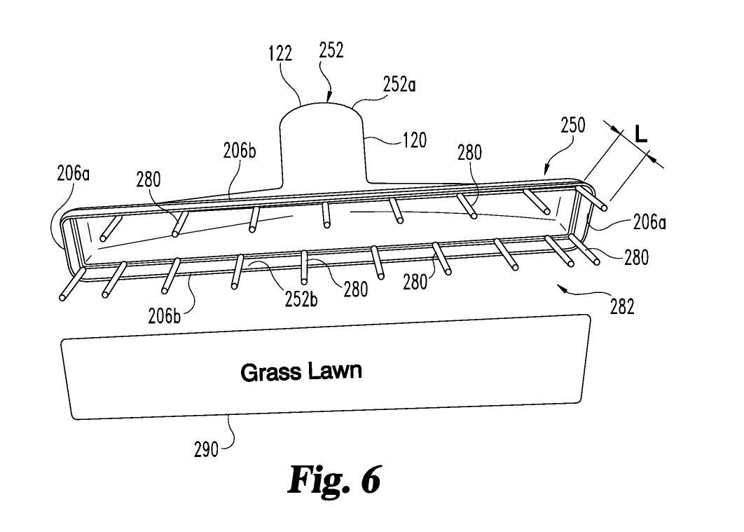

By way of nonlimiting example, FIG. 6 illustrates a different attachment 250 that lacks a grating; where like reference numerals refer to like features previously described. Attachment 250 may be used in place of attachment 50 or any of attachments 40 of system 20, and vice versa. Accordingly, attachment 250 includes collar 120 defining rim 122 as previously described. Attachment 250 includes conduit 252 extending between inlet 252b and outlet 252a. Inlet 252b is defined by two pair of opposing sides 206a and 206b of attachment 250, respectively. Inlet 252b has a generally rectangular profile as described for attachment 50, but inlet 252b appears with a different aspect ratio if the different illustrations are dimensionally compared.

Attachment 250 further includes a pattern 282 of spaced-apart, rigid projections 280. Projections 280 are each elongated and each extends from inlet 252b a distance L as previously described. In one form, L is about 1.5 inches, although in other embodiments L may be no more than one half an inch. In pattern 282, projections 280 are positioned about inlet 252b, and extend along each opposing side 206b of attachment 250. In one form, projections 280 number at least twelve. In another form, the projections 280 number at least 18. In a further form, projections 280 are made of metal. For another form, projections 280 are made from a suitable polymeric resin material integrally formed with sides 206b and/or sides 206a of attachment 250.

Referring further to FIG. 6, a landscaping medium 290 is further depicted diagrammatically as being a grass lawn 300. In one application, it is preferred to use the illustrated embodiment of attachment 250 to rake or groom grass lawn 300, aerating, freeing and/or removing dead grass, cut grass, or similar material as debris, but it is not limited to such application. Referring back to FIG. 2, in the alternative, landscaping medium 46 is depicted diagrammatically as being at least one of bark chips, bark pieces, wood chips, wood pieces, rocks, pebbles, cobbles, crushed stone, mulch, and pea-sized or larger gravel material 49. In one application, it is preferred to use the illustrated embodiment of attachment 50 to rake or groom material 49, separating sand, dirt, and other fine particulate material as debris 48, but it is not limited to such application.

In a more preferred embodiment, selection is made among different configurations of attachments based on the type/nature of the landscaping material to which the selected attachment is applied. By way of nonlimiting example, selection of one attachment is made for grass lawn application and a different attachment for application to at least one of bark chips, bark pieces, wood chips, wood pieces, rocks, pebbles, cobbles, crushed stone, mulch, and pea-sized or larger gravel material, or the like. The selected attachment may be coupled to the vacuum cleaner to apply suction to clean the desired landscaping medium.

Different attachments according the present application may or may not include projections/teeth or a grating. If there is a grating, it may or may not be carrying projections/teeth, which may or may not extend away from the inlet—if there are any projections/teeth at all. For attachments that have projections/teeth, they may differ in terms of various features, such as pattern, orientation, number, composition, application material, length, or any combination of these—just to name a few.

For applications differing in projection/tooth length, one preferred embodiment includes projections/teeth extending away from the inlet a distance of at least about 0.750 of an inch. In a more preferred embodiment, the distance is also less than or equal to about 1.750 inches, resulting in a range from about 0.750 of an inch through about 1.750 inches. In another more preferred embodiment, this range is from about 0.875 of an inch through about 1.625 inches. In further embodiment that is more preferred, this range is from about 1.125 inches through about 1.875 inches. For an even more preferred embodiment, the distance is in a range from about 1.250 inches through about 1.750 inches. In another embodiment that is even more preferred, the distance is in a range from about 1.000 inch through about 1.500 inches.

For those varying in pattern or orientation, one preferred embodiment includes at least two rows of projections/teeth disposed along opposite sides of the inlet. In a more preferred embodiment, at least 4 of the projections extend along a first side of the inlet and at least another 4 of the projections extend along a second side of the inlet opposite the first side. In another more preferred embodiment, the projections/teeth are arranged in at least 3 rows with each including at least 3 of the projections/teeth, a first one of the rows extends along one side of the inlet, a second one of the rows extends along another side of the inlet opposite the one side, and a third one of the rows extends between the first one of the rows and the second one of the rows.

For those attachments varying in the number of projections/teeth, one preferred embodiment includes at least 6 projections/teeth. In a more preferred embodiment, the projections/teeth number at least 9. In an even more preferred embodiment, the projections/teeth number at least 12.

For those embodiments varying in the application material to which the projections/teeth are applied, in one preferred embodiment the landscaping medium includes a green lawn. For a more preferred form of this embodiment, the distance L is about 1.5 inches. In another preferred embodiment, the landscaping medium includes at least one of bark chips, bark pieces, wood chips, wood pieces, rocks, pebbles, cobbles, crushed stone, mulch, and pea-sized or larger gravel material. For a more preferred form of this embodiment, the distance L is at least about 0.750 of an inch.

For those projections/teeth varying in composition, in one preferred embodiment, the projections/teeth are comprised of a thermoset or thermoplastic polymeric material. In a more preferred embodiment, at least some projections/teeth are formed integral with the shoe and collar of the attachment. In an even more preferred embodiment, the projections/teeth are comprised of metal.

In another aspect, the aspect ratio of the inlet profile is considered. In one preferred form, the aspect ratio is in a range from about 1 and to about 9. In a more preferred form, the aspect ratio is in a range from about 2 and to about 8. In an even more preferred form, the aspect ratio is in a range from about 3 and to about 7.

As used herein, projections or teeth broadly include reference to multiple tines, prongs, spikes, protrusions, and equivalents thereof.

Any theory, thesis, hypothesis, mechanism of operation, proof, or finding stated herein is meant to further enhance understanding of one or more of the inventions and is not intended to make any invention in any way dependent upon such theory, mechanism of operation, proof, or finding. It should be understood that any use of the words “preferable, preferably, preferred, more preferred, even more preferred, still more preferred, yet more preferred, further preferred, additionally preferred, and most preferred” in the description above indicates that the feature so described may be desirable, it nonetheless may not be necessary and any embodiment lacking the same comes within the scope of any corresponding invention of the present application, that scope being defined by the claims that follow. While one or more selected embodiments have been illustrated and described in detail in the drawings and foregoing description, the same is to be considered as illustrative and not restrictive in character, it being understood that only the selected embodiments have been shown and described, and that all changes, modifications and equivalents that come within the spirit of the invention(s) as defined herein or by any of the following claims are desired to be protected.

What is claimed is:

1. A method, comprising:
providing a vacuum cleaner including an attachment coupling tube;
selecting a vacuum cleaner attachment to clean a landscaping medium mixed with a finer particulate debris, the vacuum cleaner attachment defining a conduit including an intake opposite an outlet to provide fluid communication therebetween, the intake defining an intake opening, the attachment including a grating extending across the conduit to define a number of apertures sized and shaped to pass finer particulate debris therethrough while at least partially blocking the landscaping medium, and the grating carrying at least six teeth in contact with and connected to the grating, the teeth extending away from the grating out of the opening;
connecting the attachment to the attachment coupling tube;
placing the intake over the landscaping medium after the connecting of the attachment; and
operating the vacuum cleaner during the placing of the intake over the landscaping medium to apply suction through the conduit to clean the landscaping medium by separating the finer particulate matter from the landscaping medium.

2. The method of claim 1, which includes raking the landscaping medium with the teeth during the operating of the vacuum cleaner.

3. The method of claim 1, wherein the landscaping medium includes at least one of bark chips, bark pieces, wood chips, wood pieces, rocks, pebbles, cobbles, crushed stone, mulch, and pea-sized or larger gravel material; and the finer particulate debris includes at least one of sand, soil, and dirt.

4. The method of claim 1, wherein pieces of the finer particulate debris each have a first maximum dimension, pieces of the landscaping medium each have a second maximum dimension, and the first maximum dimension is at least 25% less than the second maximum dimension.

5. The method of claim 1, which includes separating the finer particulate debris with a first maximum dimension from the landscaping medium with a second maximum dimension, the first maximum dimension being one centimeter or less and the second maximum dimension being greater than one centimeter.

6. The method of claim 1, wherein the teeth project out of the opening at least 0.750 of an inch, the teeth number at least 12, the teeth are arranged in 3 or more rows, the rows each include 3 or more of the teeth, a first one of the rows extends along a first side of the intake, a second one of the rows extends along a second side of the intake opposite the first side, and a third one of the rows extends between the first row and the second row.

7. An apparatus, comprising:
a vacuum cleaner suction source;
a debris collection vessel;
a vacuum cleaner head in fluid communication with the vacuum cleaner suction source and the debris collection vessel, the vacuum cleaner head defining a conduit therethrough with an intake opening and the vacuum cleaner head including a grating extending across the conduit and six or more teeth connected to the grating in contact therewith and extending away from the grating toward out of the intake opening, a margin of the conduit circumscribing the teeth, the grating defining a number of apertures sized and shaped to selectively separate debris from a coarser medium when suction is provided by the suction source through the conduit of the vacuum cleaner head with the intake opening placed over the coarser medium within a proximity sufficient to be operative.

8. The apparatus of claim 7, wherein the teeth extend out of the conduit from the intake opening a distance of at least 0.750 of an inch and number at least 9.

9. The apparatus of claim 7, further comprising:
a tube operable to provide the fluid communication of the vacuum cleaner head with the debris collection vessel and the vacuum suction source;
means for detaching the vacuum cleaner head from the tube and reattaching the vacuum cleaner head to the tube to exchange with one or more different vacuum cleaner attachments.

10. The apparatus of claim 7, wherein the teeth number at least 12, the teeth are arranged in 3 or more rows, the rows each include 3 or more of the teeth, a first one of the rows extends along a first side of the intake opening, a second one of the rows extends along a second side of the intake opening opposite the first side, and a third one of the rows extending between the first row and the second row.

11. The apparatus of claim 7, wherein the teeth number at least 12, the teeth are each connected to the grating between two or more of the apertures.

12. The apparatus of claim 7, wherein the apertures each have a size and a shape approximately the same from one to another, and the apertures number at least 6.

13. The apparatus of claim 12, further comprising means for providing different configurations of the vacuum cleaner head in response to application to differing types of the coarser medium.

14. The apparatus of claim 13, further comprising means for providing the suction source and the debris collection vessel coupled together.

15. The apparatus of claim 7, wherein each one of the teeth are positioned to be approximately equidistant from one other of the teeth.

16. The apparatus of claim 7, further comprising a tube coupling the vacuum cleaner head to the vacuum source and the debris collection vessel, and wherein the vacuum cleaner head is in the form of an attachment operatively detachable from and reattachable to the tube to allow for exchange of one or more different attachments to provide one or more correspondingly different vacuum cleaner heads.

17. A device, comprising: a vacuum cleaner attachment defining a conduit therethrough, the conduit extending between an inlet to an outlet, the outlet being sized and shaped to connect to and detach from a vacuum cleaner to allow exchange with one or more other vacuum cleaner attachments, the vacuum cleaner attachment including a grating and 6 or more projections connected to the grating, the projections being spaced apart from each other and protruding from the grating out of the conduit past the inlet a distance of at least 0.750 of an inch, the grating extending across the conduit to define a number of apertures circumscribed by a conduit margin, the apertures being sized and shaped to selectively separate debris from a coarser medium when suction is applied through the conduit, the projections each being connected to and in contact with the grating between two or more of the apertures.

18. The device of claim 17, further comprising the vacuum cleaner in fluid communication with the attachment.

19. The device of claim 17, wherein the projections number at least 12, the projections are arranged in 3 or more rows, the rows each include 3 or more of the projections, a first one of the rows extends along a first side of the inlet, a second one of the rows extends along a second side of the inlet, and a third one of the rows extends between the first one of the rows and the second one of the rows.

20. The device of claim 19, wherein the distance is in a range of about 0.875 inch to about 1.625 inches.

21. A method, comprising:
providing a vacuum cleaner including an attachment coupling tube;
selecting a landscaping medium with debris to remove therefrom;
selecting a vacuum cleaner attachment in accordance with the landscaping medium selected, the vacuum cleaner attachment defining a conduit therethrough, the conduit extending from an inlet to an outlet, the attachment further including at least six rigid projections, the projections being spaced apart from one another proximate to the inlet and each extending away from the inlet a distance of at least 0.750 of an inch; and
operating the vacuum cleaner with the attachment connected to the attachment coupling tube to apply suction through the conduit while raking the landscaping medium with the projections to remove debris from the landscaping medium.

22. The method of claim 21, wherein the projections number at least 12, a first 4 of the projections extend along a first side of the inlet, a second 4 of the projections extend along a second side of the inlet opposite the first side, and the distance is less than or equal to 1.750 inches.

23. The method of claim 22, wherein the landscaping medium includes a grass lawn and the distance is in a range from about 1.250 inches through about 1.750 inches.

24. The method of claim 22, wherein the landscaping medium includes at least one of bark chips, bark pieces, wood chips, wood pieces, rocks, pebbles, cobbles, crushed stone, mulch, and pea-sized or larger gravel material and the attachment includes a grating extending across the conduit to define a number of apertures sized and shaped to pass the debris therethrough while at least partially blocking the landscaping medium.

25. The method of claim 21, wherein the landscaping medium includes at least one of bark chips, bark pieces, wood chips, wood pieces, rocks, pebbles, cobbles, crushed stone, mulch, and pea-sized or larger gravel material, the attachment includes a grating extending across the conduit to define a number of apertures sized and shaped to pass the debris therethrough while at least partially blocking the landscaping medium, the distance is in a range from about 1.000 inch through about 1.500 inches, 3 or more of the projections connect to the grating between two or more of the apertures, and the 3 or more projections extend from the grating through the conduit and out of inlet.

26. The method of claim 21, wherein the landscaping medium includes at least one of bark chips, bark pieces, wood chips, wood pieces, rocks, pebbles, cobbles, crushed stone, mulch, and pea-sized or larger gravel material, the attachment includes a grating extending across the conduit to define a number of apertures sized and shaped to pass the debris therethrough while at least partially blocking the landscaping medium, the projections number 9 or more and are arranged in at least 3 rows with each including at least 3 of the projections, a first one of the rows extends along one side of the inlet, a second one of the rows extends along another side of the inlet opposite the one side, and a third one of the rows extends from the grating between the first one of the rows and the second one of the rows.

27. The method of claim 21, wherein the landscaping medium includes a grass lawn and the distance is in a range from about 1.125 inches through about 1.875 inches.
